(19) United States
(12) Patent Application Publication
(10) Pub. No.: US 2022/0394541 A1
(43) Pub. Date: Dec. 8, 2022

(54) FLOW-BASED END-TO-END QUALITY OF SERVICE MANAGEMENT

(71) Applicant: QUALCOMM Incorporated, San Diego, CA (US)

(72) Inventors: Naeem AKL, Somerville, NJ (US); Karl Georg HAMPEL, Jersey City, NJ (US); Luis Fernando Brisson LOPES, Swindon (GB); Ozcan OZTURK, San Diego, CA (US); Sebastian SPEICHER, Wallisellen (CH); Francesco PICA, San Diego, CA (US)

(21) Appl. No.: 17/662,756

(22) Filed: May 10, 2022

Related U.S. Application Data
(60) Provisional application No. 63/202,339, filed on Jun. 7, 2021.

(51) Int. Cl. H04W 28/02

(52) U.S. Cl. CPC H04W 28/0268

(57) ABSTRACT

Various aspects of the present disclosure generally relate to wireless communication. In some aspects, a network node may identify a marking of one or more packets, of a quality of service (QoS) flow, with a transport layer identifier associated with a QoS of the QoS flow, wherein the transport layer identifier persists between a user plane function (UPF) and a user equipment (UE). The network node may provide the one or more packets via one or more tunnels with the QoS of the QoS flow. Numerous other aspects are described.

### CROSS-REFERENCE TO RELATED APPLICATION

This Patent Application claims priority to U.S. Provisional Patent Application No. 63/202,339, filed on Jun. 7, 2021, entitled “FLOW-BASED END-TO-END QUALITY OF SERVICE MANAGEMENT,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for flow-based end-to-end quality of service (QoS) management.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a network node for wireless communication includes a memory and one or more processors, coupled to the memory, configured to: identify a marking of one or more packets, of a quality of service (QoS) flow, with a transport layer identifier associated with a QoS of the QoS flow, wherein the transport layer identifier persists between a user plane function (UPF) and a user equipment (UE); and provide the one or more packets via one or more tunnels with the QoS of the QoS flow.

In some aspects, a method of wireless communication performed by a network node includes identifying a marking of one or more packets, of a QoS flow, with a transport layer identifier associated with a QoS of the QoS flow, wherein the transport layer identifier persists between a UPF and a UE; and providing the one or more packets via one or more tunnels with the QoS of the QoS flow.

In some aspects, a non-transitory computer-readable medium storing a set of instructions for wireless communication includes one or more instructions that, when executed by one or more processors of a network node, cause the network node to: identify a marking of one or more packets, of a QoS flow, with a transport layer identifier associated with a QoS of the QoS flow, wherein the transport layer identifier persists between a UPF and a UE; and provide the one or more packets via one or more tunnels with the QoS of the QoS flow.

In some aspects, an apparatus for wireless communication includes means for identifying a marking of one or more packets, of a QoS flow, with a transport layer identifier associated with a QoS of the QoS flow, wherein the transport layer identifier persists between a UPF and a UE; and means for providing the one or more packets via one or more tunnels with the QoS of the QoS flow.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3A and 3B are diagrams illustrating an example of a user plane protocol stack and a control plane protocol stack, in accordance with the present disclosure.

FIG. 4 is a diagram illustrating an example of access networks and backhaul networks using separate radio access networks (RANs), in accordance with the present disclosure.

FIGS. 5A-5C are diagrams illustrating an example associated with end-to-end quality of service (QoS) management, in accordance with the present disclosure.

FIG. 6 is a diagram illustrating an example process associated with end-to-end QoS management, in accordance with the present disclosure.

FIG. 7 is a diagram of an example apparatus for wireless communication, in accordance with the present disclosure.

FIG. 8 is a diagram of end-to-end QoS management, in accordance with the present disclosure.

FIG. 9 is a diagram of an open radio access network (O-RAN) architecture, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

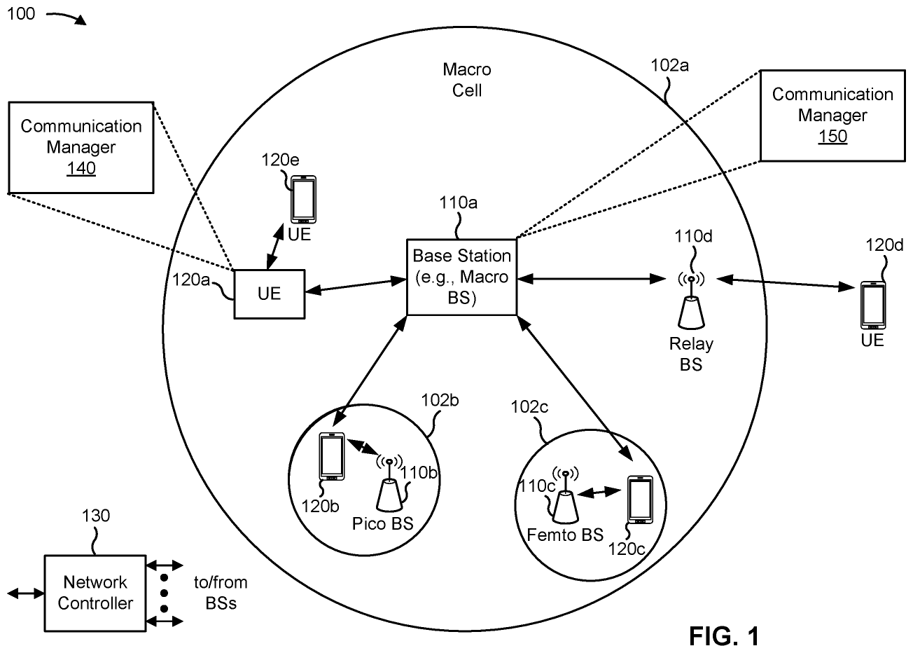

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

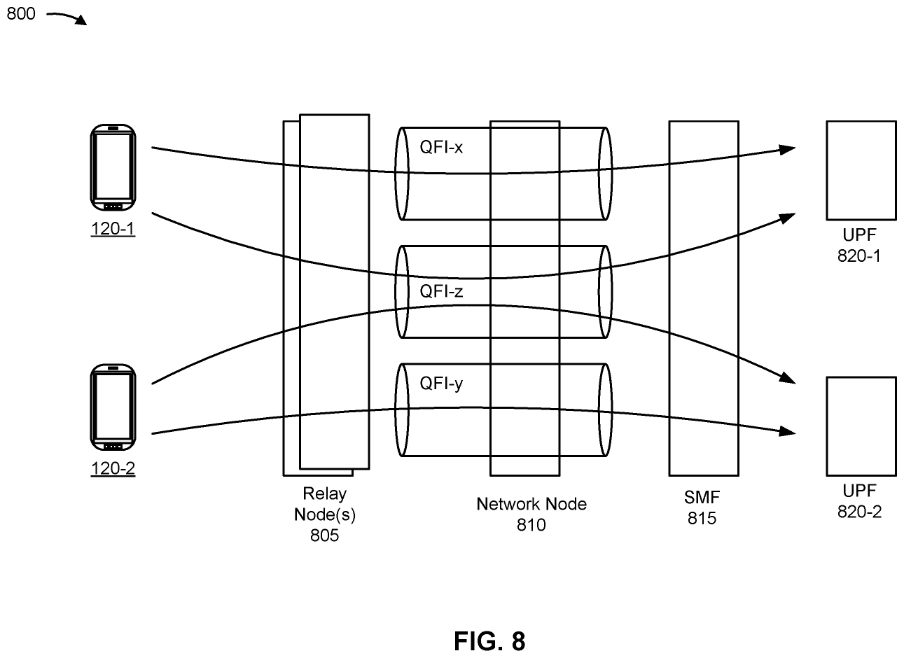

In some aspects, the term “base station” (e.g., the base station 110) or “network node” or “network entity” may refer to an aggregated base station, a disaggregated base station (e.g., described in connection with FIG. 8), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

In some aspects, a network node, such as a base station 110, a UE 120, or a component thereof, among other examples, may include a communication manager 140 or 150. As described in more detail elsewhere herein, the communication manager 140 or 150 may identify a marking of one or more packets, of a quality of service (QoS) flow, with a transport layer identifier associated with a QoS of the QoS flow, wherein the transport layer identifier persists between a user plane function (UPF) and a user equipment (UE); and provide the one or more packets via one or more tunnels with the QoS of the QoS flow. Additionally, or alternatively, the communication manager 140 or 150 may perform one or more other operations described herein.

As indicated above, FIG. 1 is provided as an example. Other examples may differ from what is described with regard to FIG. 1.

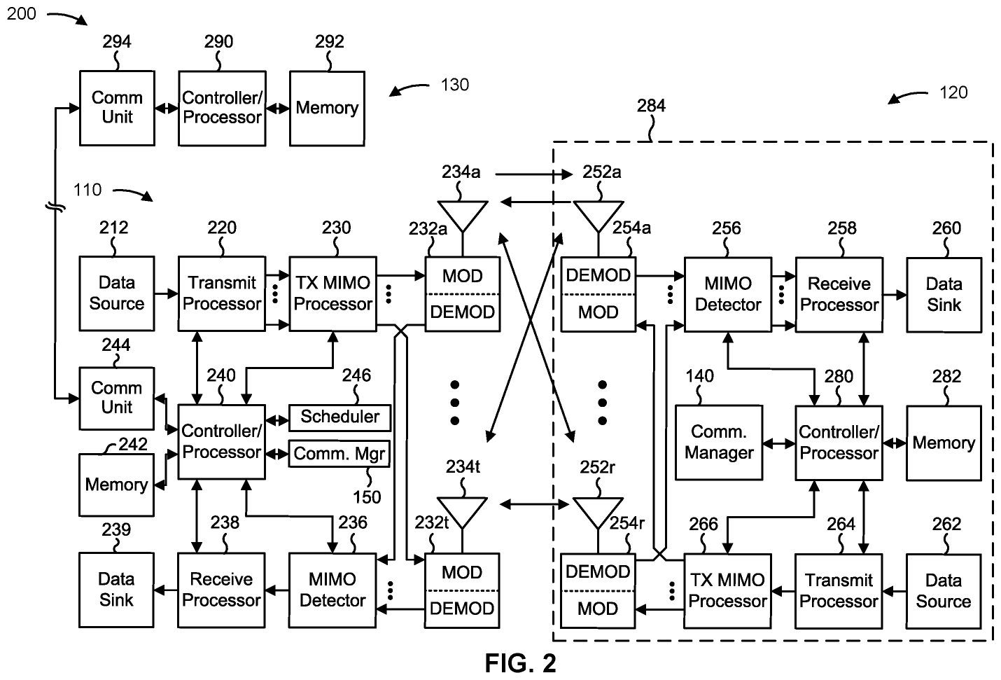

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

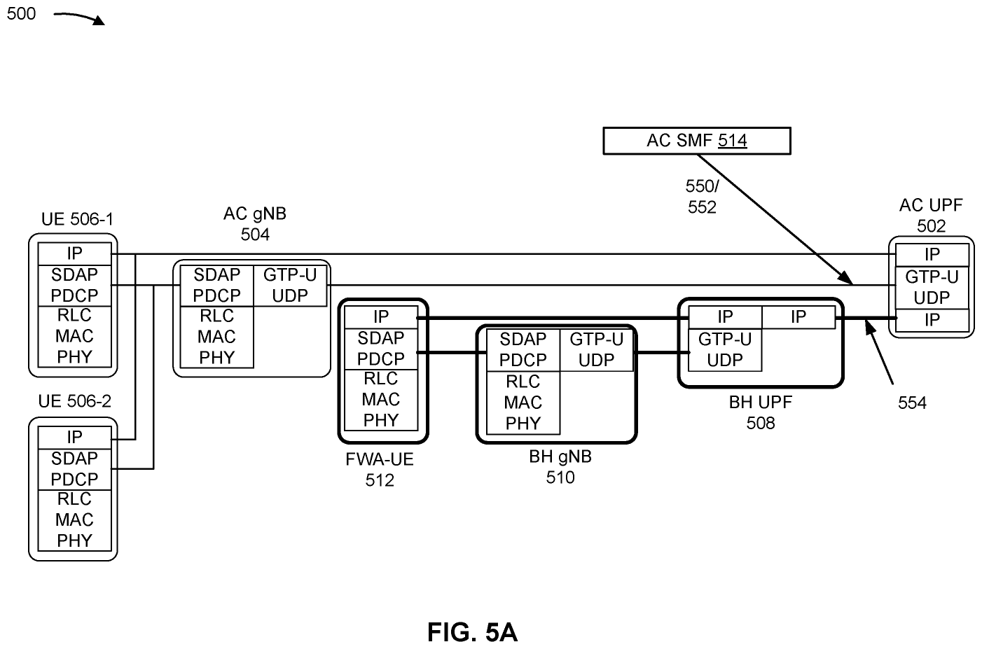

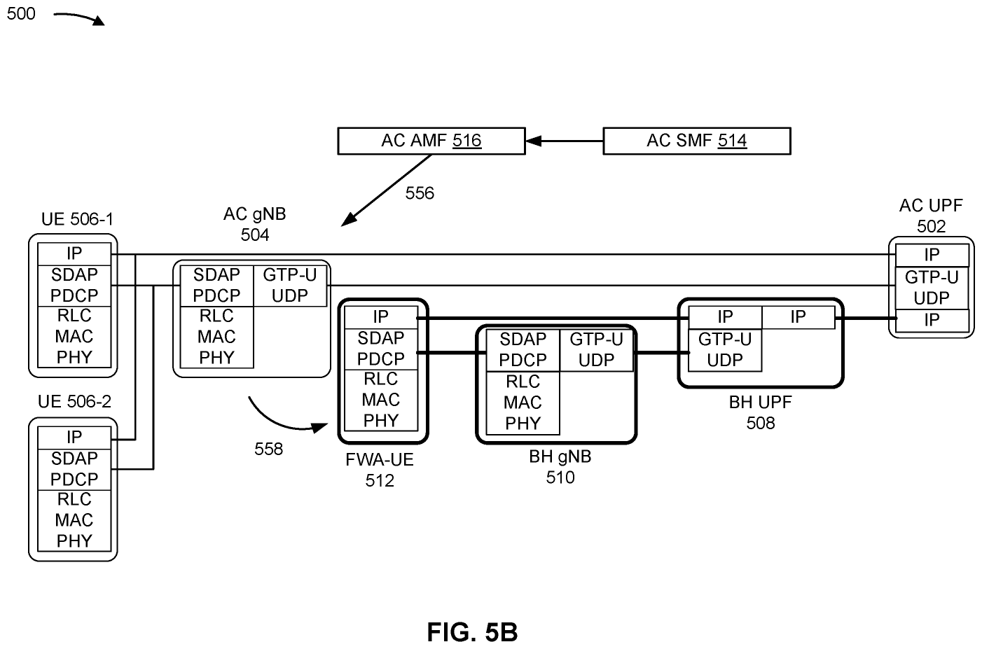

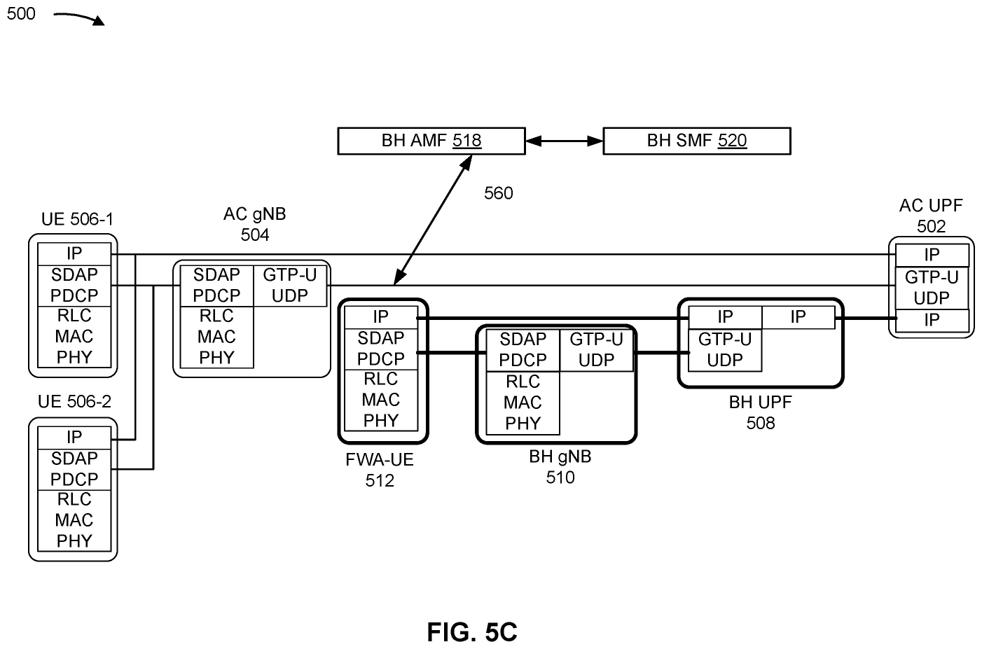

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-8).

The controller/processor 240 of the base station 110, the controller/processor 280 of the UE 120, and/or any other component(s) of FIG. 2 may perform one or more techniques associated with end-to-end quality of service (QoS) management, as described in more detail elsewhere herein. In some aspects, the network node described herein is the base station 110 (or a core network device or function communicating therewith) or the UE 120, is included in the base station 110 or the UE 120, or includes one or more components of the base station 110 or the UE 120 shown in FIG. 2. For example, the controller/processor 240 of the base station 110, the controller/processor 280 of the UE 120, and/or any other component(s) of FIG. 2 may perform or direct operations of, for example, process 500 of FIG. 5 and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5 and/or other processes as described herein. In some examples, executing instructions may include running the instructions, converting the instructions, compiling the instructions, and/or interpreting the instructions, among other examples.

In some aspects, a network node, such as a base station 110, a UE 120, or a component thereof, among other examples, includes means for identifying a marking of one or more packets, of a QoS flow, with a transport layer identifier associated with a QoS of the QoS flow, wherein the transport layer identifier persists between a user plane function (UPF) and a UE; and/or means for providing the one or more packets via one or more tunnels with the QoS of the QoS flow. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the network node to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

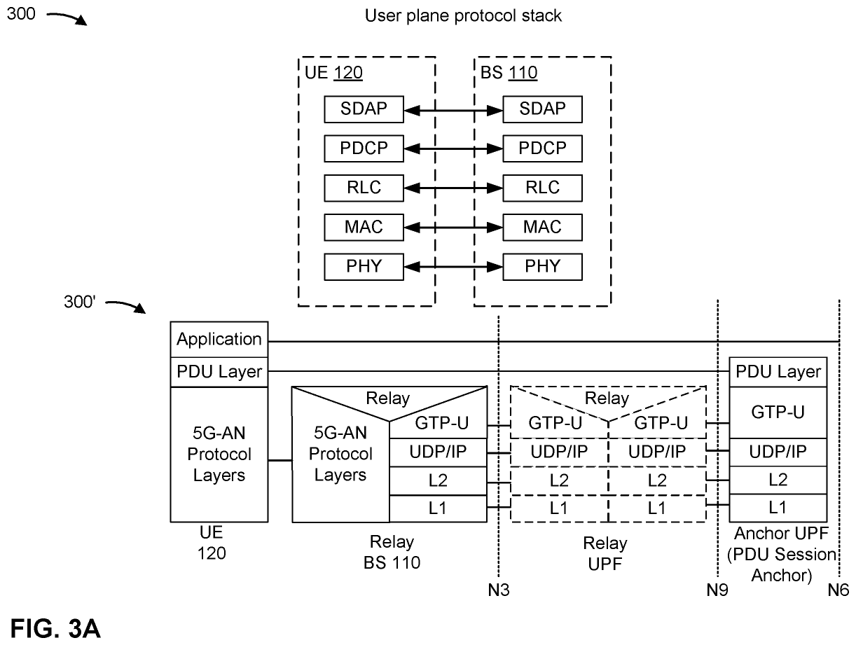

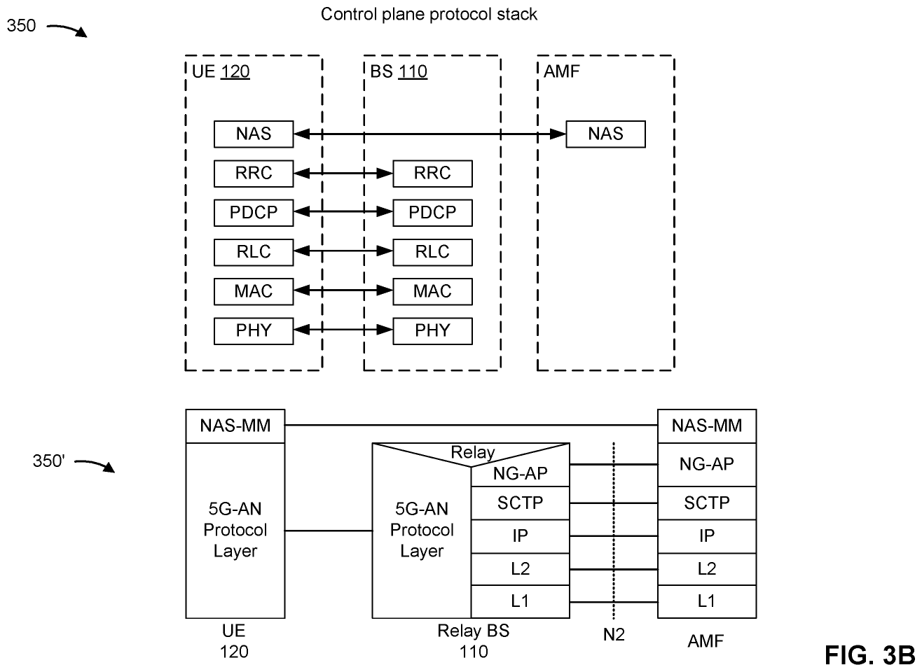

FIGS. 3A and 3B are diagrams illustrating examples 300/300′ and 350/350′ of a user plane (UP) protocol stack and a control plane (CP) protocol stack for a base station 110 and a core network in communication with a UE 120, in accordance with the present disclosure.

As shown in FIG. 3A, and by example 300, on the user plane, the UE 120 and the base station 110 may include respective physical (PHY) layers, medium access control (MAC) layers, radio link control (RLC) layers, packet data convergence protocol (PDCP) layers, and service data adaptation protocol (SDAP) layers. A user plane function (UPF) may handle transport of user data between the UE 120 and the base station 110. Although some aspects are described herein in terms of a base station 110, aspects described herein may relate to another type of network node. On the control plane, the UE 120 and the base station 110 may include respective radio resource control (RRC) layers. Furthermore, the UE 120 may include a non-access stratum (NAS) layer in communication with an NAS layer of an access and management mobility function (AMF). The AMF may be associated with a core network associated with the base station 110, such as a 5G core network (5GC) or a next-generation radio access network (NG-RAN). Collectively, the aforementioned layers of example 300 may be termed “5G access node protocol layers” or “5G-AN protocol layers.”

As further shown in FIG. 3A, and by example 300′, on the user plane, the UE 120, a relay base station 110, a relay UPF, and an anchor UPF may include respective protocol stacks. The UE 120 may include the 5G-AN protocol layers, a protocol data unit (PDU) layer, and an application layer. The application layer may interface with one or more network nodes (not shown) via, for example, an N6 interface. The PDU session may be an Internet Protocol (IP) version 4 (IPv4) or IP version 6 (IPv6) session that conveys IPv4 packets, IPv6 packets, or a combination thereof. The PDU session may be an Ethernet-type session that conveys Ethernet frames. The relay base station 110 may include corresponding 5G-AN protocol layers for the 5G-AN protocol layers of the UE 120, and may include a set of a general packet radio service (GPRS) tunneling protocol (GTP) user data tunneling (GTP-U) protocol stack layers for interfacing with the relay UPF and the anchor UPF, such as a layer 1 (L1) layer (e.g., a PHY layer), a layer 2 (L2) layer (e.g., a MAC layer), and a user datagram protocol (UDP) layer/Internet Protocol (IP) layer (e.g., a transport layer). The GTP-U protocol stack supports tunneling of user data over the N3 and/or N9 interface (or N4 interface, not shown) (e.g., between the relay base station 110 and the relay UPF and anchor UPF) in a core network. A GTP entity may encapsulate end user PDUs on a per PDU session level and may convey a marking associated with a QoS flow. The relay UPF may include a set of GTP-U protocol stack layers corresponding to and interfacing with the relay base station 110 over, for example, an N3 interface and a set of GTP-U protocol stack layers for interfacing with the anchor UPF over, for example, an N9 interface. The anchor UPF, which may be a PDU session anchor, may include a set of GTP-U protocol stack layers for interfacing with the relay UPF over, for example, the N9 interface and a PDU layer corresponding to the PDU layer of the UE 120.

As shown in FIG. 3B, and by example 350, a control plane function (CPF), such as an AMF, may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 3B, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

As further shown in FIG. 3B, and by example 350′, on the control plane, the UE 120, a relay base station 110, and an AMF may include respective protocol stacks. The UE 120 may include the 5G-AN protocol layers and an NAS mobility management (MM) (NAS-MM) layer. NAS-MM may be a protocol for MM functionality, such as registration management functionality, connection management functionality, user plane connection activation functionality, or user plane connection deactivation functionality, among other examples. Additionally, the NAS-MM layer may include an entity for ciphering or integrity protection of NAS signaling The relay base station 110 may include corresponding 5G-AN protocol layers for the 5G-AN protocol layers of the UE 120, and may include a set of protocol stack layers for interfacing with AMF, such as an L1 layer (e.g., a PHY layer), an L2 layer (e.g., a MAC layer), an IP layer (e.g., a transport layer), a stream control transmission protocol (SCTP) layer (e.g., a transport layer), and an NG application protocol (NG-AP) layer. The AMF may include a set of protocol stack layers corresponding to, and for interfacing with, the relay base station 110 over the N2 interface and an NAS-MM layer for interfacing with a corresponding NAS-MM layer of the UE 120.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the base station 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. Some QoS flows may be associated with a guaranteed flow bit rate (GBR) and may be termed “GBR QoS Flows.” Other QoS flows may not require a GBR and may be termed “non-GBR QoS Flows.” Additionally, some communications systems may support reflective QoS functionality, in which a UE may map uplink user plane traffic to a QoS flow, without a session management function (SMF) provided QoS rule, and the UE may apply the mapping for an IP PDU session and/or an Ethernet PDU session. Additional details regarding reflective QoS functionality may be found, for example, in 3GPP Technical Specification (TS) 23.501 version 16.6.0 Release 16.

User plane traffic with the same QFI within a PDU session may be assigned the same or similar traffic handling characteristics, such as the same scheduling or the same admission threshold, among other examples. The QFI may be conveyed in an encapsulation header on an N3 or N9 interface (e.g., without a change to an end-to-end packet header). The QFI may be dynamically assigned or may be based at least in part on a 5G QoS identifier (5QI).

A QoS flow may be associated with a QoS profile, which an SMF may provide to an access node (AN) (e.g., the base station 110) via an AMF (e.g., over an N2 interface) or which may be statically configured for the AN. The QoS flow may also be associated with one or more QoS rules, one or more QoS flow level parameters associated with the one or more QoS rules (e.g., provided by an SMF to a UE via an AMF or derived using a reflective QoS functionality), or one or more packet detection rules (PDRs) for uplink or downlink (e.g., provided by an SMF to a UPF), among other examples.

Network nodes, such as UEs, base stations, or the UPF, among other examples, may map QoS flows to AN resources for communication between a UE 120 and a base station 110. For example, on a downlink, a UPF may classify a data packet and convey a classification to a base station 110, and the base station 110 may bind a QoS flow associated with the data packet and the classification to a set of communication resources. Similarly, on an uplink, a UE may evaluate data, identify a QoS rule for the data, and bind a QoS flow associated with the data to a set of communication resources based at least in part on the QoS rule. Additional details regarding QoS flow mapping and binding to resources may be found, for example, in 3GPP TS 23.501 version 16.6.0 Release 16.

The RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and padding. Each logical channel may be associated with a corresponding RLC entity. Thus, RLC configuration may be performed on a per-logical channel basis.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1). A MAC entity of the MAC layer may perform scheduling operations at, for example, a base station 110 for both uplink and downlink communication. The MAC entity may multiplex logical channels into transport channels and insert logical channel identifiers (LCIDs) to enable demultiplexing at a receiver (e.g., a corresponding MAC entity of a destination device). The MAC entity may prioritize logical channels conveying traffic for radio bearers of different UEs or radio bearers of a single UE.

On the receiving side (e.g., if the UE 120 is receiving a downlink communication or the base station 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload. Additional details regarding a layer structure may be described in, for example, 3GPP TS 38.300 version 15.8.0 Release 15.

As indicated above, FIGS. 3A and 3B are provided as examples. Other examples may differ from what is described with regard to FIGS. 3A and 3B.

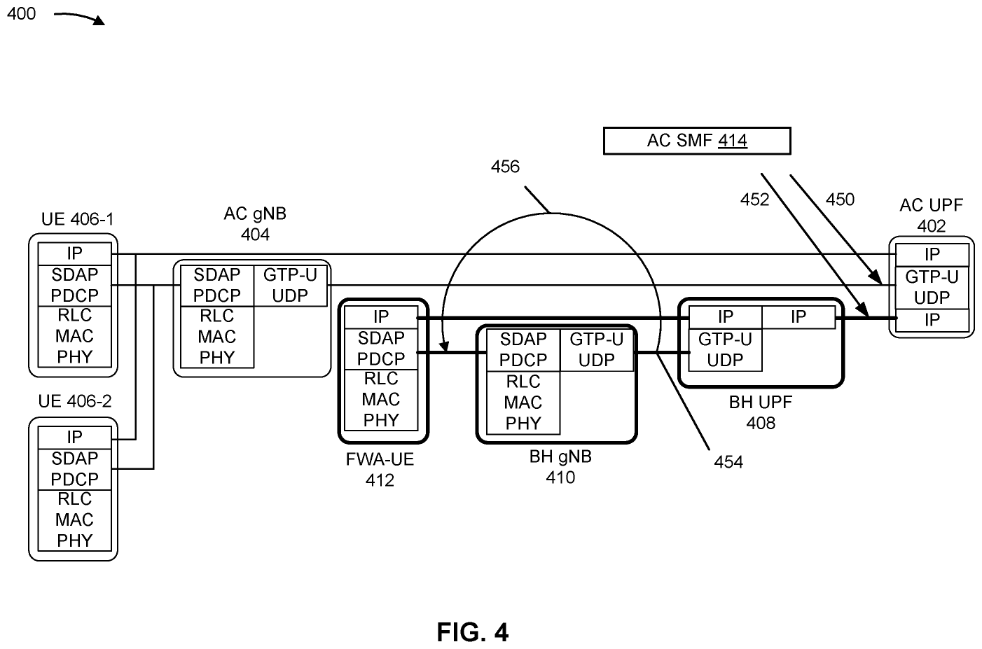

FIG. 4 is a diagram illustrating an example 400 of access networks and backhaul networks using separate RANs, in accordance with the present disclosure. As shown in FIG. 4, an access (AC) network may include an AC UPF 402, an AC gNB 404, a UE 406-1 and a UE 406-2. As further shown in FIG. 4, a backhaul (BH) network may include a BH UPF 408, a BH gNB 410, and a fixed wireless access (FWA) UE (FWA-UE) 412 (e.g., a customer premises equipment (CPE)). In some aspects, a CPE may include FWA UE 412 and AC gNB 404. In some aspects, the CPE may also include a local UPF (e.g., to support local breakout traffic, such as within a home or enterprise). In some aspects, FWA UE 412 may comprise an IAB mobile terminal (MT). Although two UEs 406 are described herein, other deployments may have multiple QoS flows associated with a single UE 406 or may have other quantities of UEs 406.

As further shown in FIG. 4, and by reference number 450, an AC SMF 414 may assign a first QFI to a first QoS flow directed between AC UPF 402 and UE 406-1, and a second QFI to a second QoS flow directed between AC UPF 402 and UE 406-2. For example, AC SMF 414 may assign the first QFI to indicate first QoS parameters (e.g., a first packet delay budget (PDB), bit rate, or packet error rate, among other examples) for the first QoS flow associated with UE 406-1, and a second QFI to indicate second QoS parameters (e.g., a second PDB, bit error rate, or packet error rate, among other examples) for the second QoS flow associated with UE 406-2.

As further shown in FIG. 4, and by reference number 452, AC SMF 414 may provide a packet marking value to AC UPF 402. For example, AC SMF 414 may provide a packet marking value to AC UPF 402 for the first QFI and the second QFI. However, the packet marking value may be the same packet marking value for the first QFI and the second QFI. This may result from AC SMF 414 using a 6 bit differentiated services code point (DSCP) as an indicator of the packet marking value, which may not have enough bits to differentiate the first QFI and the second QFI.

As further shown in FIG. 4, and by reference number 454, PDUs associated with the aforementioned same packet marking value are mapped to the same QFI at BH UPF 408. As shown by reference number 456, the PDUs, mapped to the same QFI, are mapped to the same DRB and the same logical channel in the BH network (e.g., a BH RAN). For example, when PDUs are mapped to the same QFI, the BH gNB 410 maps the QFI to a single DRB and thus to a single logical channel, which may result in a lack of QoS differentiation between the first QoS flow and the second QoS flow. As a result of a lack of QoS flow differentiation, different scheduling parameters or priority handling parameters, among other examples, are not satisfied for each QoS flow. In this case, end-to-end QoS management is not achieved, which may result in some data failing to achieve a configured type of QoS (e.g., a configured scheduling or priority handling), poor performance for some network services, or inefficient use of network resources, among other examples.

As indicated above, FIG. 4 is provided as an example. Other examples may differ from what is described with regard to FIG. 4.

Some aspects described herein enable end-to-end QoS management. For example, an access network may mark IP headers of data for particular end-to-end flows, which may correspond to QoS flows. An access SMF may configure a mapping between a QFI and the IP header marking to enable differentiation by an access UPF. In this case, the access UPF can use the mapping to transmit PDUs in packets with header fields set based at least in part on the IP header marking, which may enable differentiation of QoS flows. In this way, network nodes, such as a base station, a UE, an AMF, an SMF, or a UPF, among other examples, enable end-to-end QoS management, thereby enabling QoS differentiation (e.g., differentiated scheduling or priority handling), improved performance, or increased efficiency of network resource utilization, among other examples.

FIGS. 5A-5C are diagrams illustrating an example 500 of access networks and backhaul networks using separate RANs, in accordance with the present disclosure. As shown in FIG. 5A, example 500 may include a set of network nodes (e.g., UEs 120, base stations 110, or components thereof, among other examples) forming an AC network with a first RAN and a BH network with a second RAN. The AC network may include an AC UPF 502, an AC gNB 504, a UE 506-1 and a UE 506-2. The BH network may include a BH UPF 508, a BH gNB 510, and an FWA-UE 512. In some aspects, AC gNB 504 and FWA-UE 512 may be co-located with a common IP endpoint. In some aspects, FWA-UE 512 may be a CPE, such as a UE 120.

As further shown in FIG. 5A, and by reference numbers 550 and 552, an AC SMF 514 may configure a first QoS flow with a first QFI on a GTP-U tunnel between AC gNB 504 and AC UPF 502 and may provide AC UPF 502 with transport level packet marking associated with the first QFI. For example, AC SMF 514 may provide, to AC UPF 502, information identifying transport level marking (e.g., IP header marking or Ethernet header marking, among other examples), such as an outer IP address, an IPv6 flow label, or a DSCP value. In some aspects, the transport level marking may persist with the one or more packets between AC UPF 502 and UE 506 and/or between UPF 502 and a CPE that is associated with UE 506. In this case, after an IP packet reaches the CPE (which includes, for example, FWA-UE 512 and AC gNB 504), an IP header is removed and the packet is mapped by AC gNB 504 to an AN resource for transmission towards UEs 506. In this case, UEs 506 do not receive transport level marking inserted by AC UPF 502. In some aspects, network nodes described herein may assign packets to tunnels associated with the transport level marking that persists with the packets. For example, as described in more detail herein, a UE, such as a UE 506 or an FWA-UE 512, may assign a first packet to a first tunnel with a first QoS associated with first transport level marking and a second packet to a second tunnel with a second QoS associated with second transport level marking. Additionally, or alternatively, a UPF, SMF, or gNB described herein may assign a packet to a tunnel in connection with identified transport level marking of the packet.

In some aspects, AC UPF 502 may receive information, from AC SMF 514, identifying a mapping between the first QFI (for the first QoS flow on the GTP-U tunnel) and the transport level marking (e.g., the IP header marking). Additionally, or alternatively, AC UPF 502 may receive information identifying another mapping between a second QFI associated with a second QoS flow on a GTP-U tunnel and another transport level marking for the second QoS flow. As shown by reference number 554, AC UPF 502 may transmit a PDU of the first QoS flow (e.g., with the first QFI included in a GTP-U header) in a packet with a header field set with a header marking. For example, the header field may be set with an IP header marking or other transport layer marking.

As shown in FIG. 5B, and by reference number 556, AC SMF 514 may provide (e.g., via an AC AMF 516, an N11 interface, and an N2 interface) information identifying the transport level packet marking. For example, AC SMF 514 may identify the transport level packet marking used by AC UPF 502 for the first QoS flow. In this case, as shown by reference number 558, AC gNB 504 may provide the information identifying the transport level packet marking to FWA-UE 512. In another example, AC gNB 504 may derive information identifying the transport level packet marking. For example, AC gNB 504 may receive one or more packets via one or more tunnels and the one or more packets may convey a QoS associated with a QFI and may have a transport layer identifier (e.g., an IP identifier in a header of the one or more packets). In this case, AC gNB 504 may derive a mapping between the QoS associated with the QFI and the transport layer identifier that AC gNB 504 may use and/or provide to FWA-UE 512 for use in traffic processing. In an example where AC gNB 504 and FWA-UE 512 are co-located, AC SMF 514 may provide information to AC gNB 504 and to FWA-UE 512.

As shown in FIG. 5C, and by reference number 560, FWA-UE 512 may transmit a request, via a BH gNB 510 to BH AMF 518 and/or BH SMF 520. For example, FWA-UE 512 may transmit a request that BH SMF 520 bind a first service data flow, which is associated with a QoS rule of the first QoS with the first QoS flow, to a dedicated QoS flow based on one or more QoS rules. In this case, BH SMF 520 may bind the first service data flow to the dedicated QoS flow and may transmit configuration information for the dedicated QoS flow to, for example, FWA-UE 512 (e.g., via BH AMF 518) as a response. In some aspects, FWA-UE 512, UE 506-1, or UE 506-2 may be an endpoint (a UE endpoint) of a RAN and may serve as a source of the request for binding of the service data flow. Additionally, or alternatively, BH UPF 508 may be a UPF endpoint of the RAN and may serve as a source of the request for binding of the service data flow or AC gNB 510 or BH gNB 510 may be a base station endpoint and may serve as a source of the request for binding the service data flow. In other words, an endpoint device in a network may request that service data flows be bound together, as described herein.

In some aspects, BH SMF 520 may provide on or more packet detection rules to BH UPF 508 to enable mapping of traffic of the first service data flow associated with the first QoS flow to the dedicated QoS flow. BH SMF 520 may provide a QoS profile for the dedicated QoS flow to BH gNB 510, which may set up a dedicated QoS flow and configure mapping of the dedicated QoS flow to AN resources in a BH network, such as radio bearer resources or logical channel resources. In some aspects, FWA-UE 512 may receive configuration information that identifies a QoS rule, a QoS flow description, or a mapping of the dedicated QoS flow to an AN resource for communication between FWA-UE 512 and BH gNB 510, among other examples. In some aspects, FWA-UE 512 may receive a request from the AC network. For example, FWA-UE 512 may transmit a request, via NAS signaling, that the BH network establish a dedicated QoS flow with a set of parameters or characteristics, such as a PDB parameter, a bit rate parameter, a packet error rate parameter, a marking of a transport layer identifier, or an allocation of a particular QFI, among other examples. In this case, FWA-UE 512 may transmit the request to the BH SMF 520 as a response to receiving the request from the AC network.

In some aspects, FWA-UE 512 may request (e.g., using NAS signaling, such as a PDU session establishment request or PDU session modification request) that the BH SMF 520 bind a second service data flow to the dedicated QoS flow. For example, FWA-UE 512 may transmit one or more requests to bind a first service data flow and a second service data flow to respective dedicated QoS flows. In this case, BH SMF 520 may configure respective QFIs (e.g., a first QFI for the dedicated QoS flow bound to the first service data flow and a second QFI for the dedicated QoS flow bound to the second service data flow). In some aspects, in connection with binding, BH SMF 520 may configure BH UPF 508 with one or more packet detection rules (PDRs) to enable binding of a service data flow to a QoS flow, BH gNB 510 with QoS parameter or characteristics for a QoS flow that is to be set up at BH gNB 510, or FWA-UE 512 with QoS rules associated with a QoS flow of FWA-UE 512, among other examples, as described in more detail herein.

In some aspects, FWA-UE 512 may provide a QoS flow description. For example, FWA-UE 512 may provide the QoS flow description to BH SMF 520 to identify a PDB, among other examples. In this case, BH SMF 520 may configure the dedicated QoS flows with configurations associated with the QoS flow description (e.g., the dedicated QoS flows may have parameters based at least in part on an identified PDB). In some aspects, BH SMF 520 may provide a QoS profile or information identifying QoS parameters of the dedicated QoS flows to FWA-UE 512 as a response to receiving the QoS flow description (or after receiving the QoS flow description). Additionally, or alternatively, BH SMF 520 may provide the QoS profile or the information identifying the QoS parameters to BH gNB 510 or BH UPF 508, among other examples. In some aspects, the respective QFIs for the dedicated QoS flows may have the same 5QI parameter.

In this way, network nodes of the AC network and the BH network configure QoS flows for QoS differentiation In some aspects, on a downlink, the BH UPF 508 identifies a marking on one or more packets and maps an IPv6 flow to a QFI and an associated downlink tunnel using the aforementioned information regarding QoS flows and the QFI is mapped to a dedicated DRB or logical channel. Based at least in part on the BH UPF 508 having information to differentiate between the first QFI and the second QFI, BH UPF 508 enables different QoSs corresponding to the different QFIs to map to different DRBs or different logical channels with different QoS parameters, thereby achieving QoS differentiation. Similarly, on an uplink AC gNB 504 sets an IPv6 flow for a specific access network flow, and FWA-UE 512 identifies a transport layer marking and maps the IPv6 flow to a DRB or logical channel and an associated uplink tunnel separately for each QoS, thereby achieving QoS differentiation.

As indicated above, FIGS. 5A-5C are provided as an example. Other examples may differ from what is described with regard to FIGS. 5A-5C.

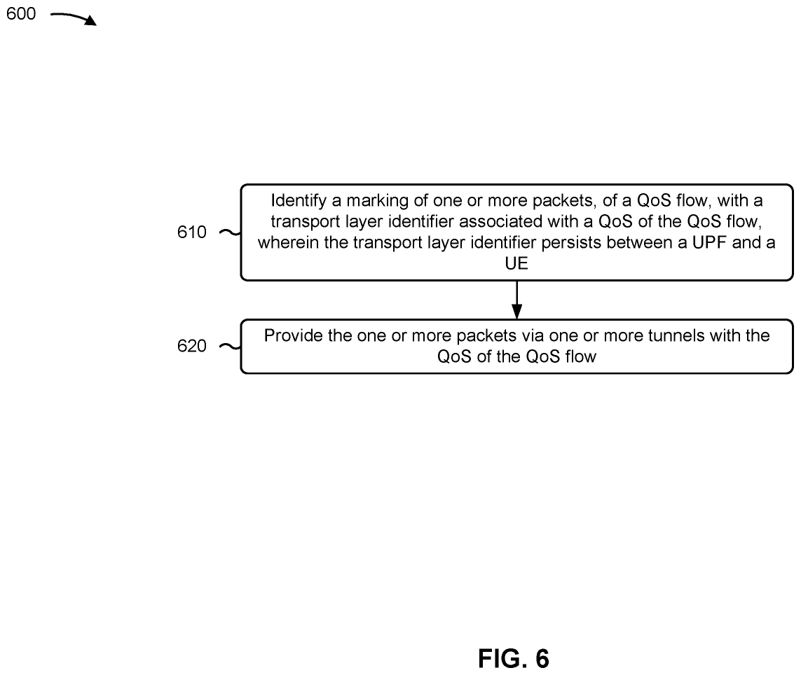

FIG. 6 is a diagram illustrating an example process 600 performed, for example, by a network node, in accordance with the present disclosure. Example process 600 is an example where the network node (e.g., base station 110, UE 120, AC UPF 502, AC gNB 504, UE 506-1, UE 506-2, BH UPF 508, BH gNB 510, FWA-UE 512, AC SMF 514, AC AMF 516, BH AMF 518, or BH SMF 520) performs operations associated with flow-based end-to-end QoS management.

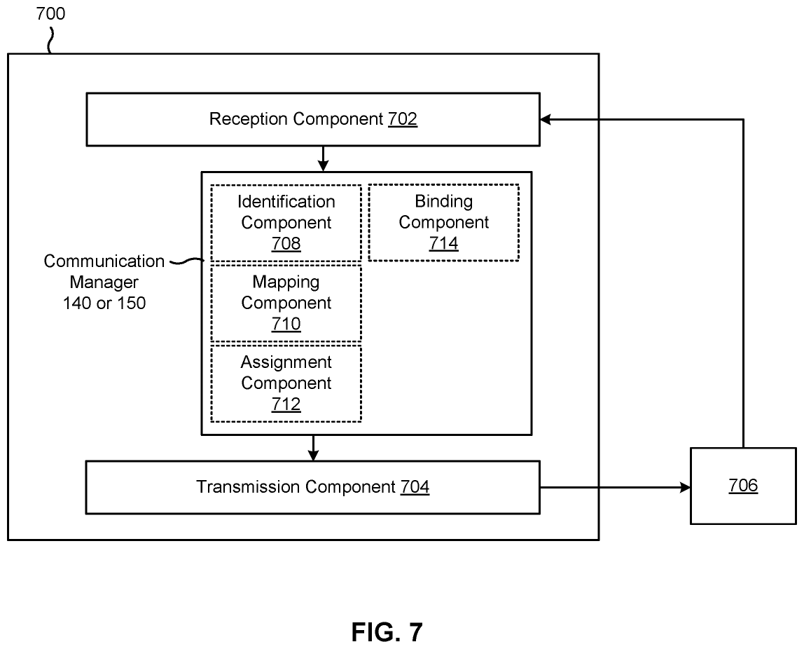

As shown in FIG. 6, in some aspects, process 600 may include identifying a marking of one or more packets, of a QoS flow, with a transport layer identifier associated with a QoS of the QoS flow, wherein the transport layer identifier persists between a UPF and a UE (block 610). For example, the network node (e.g., using communication manager 140 or 150 and/or identification component 708, depicted in FIG. 7) may identify a marking of one or more packets, of a QoS flow, with a transport layer identifier associated with a QoS of the QoS flow, wherein the transport layer identifier persists between a UPF and a UE, as described above. As further shown in FIG. 6, in some aspects, process 600 may include providing the one or more packets via one or more tunnels with the QoS of the QoS flow (block 620). For example, the network node (e.g., using communication manager 140 or 150 and/or transmission component 704, depicted in FIG. 7) may provide the one or more packets via one or more tunnels with the QoS of the QoS flow, as described above.

Process 600 may include additional aspects, such as any single aspect or any combination of aspects described below and/or in connection with one or more other processes described elsewhere herein.

In a first aspect, the network node includes a session management function or the UPF.

In a second aspect, alone or in combination with the first aspect, process 600 includes mapping the transport layer identifier to a QFI, and providing the one or more packets comprises providing the one or more packets on the one or more tunnels with the QoS using the QFI.

In a third aspect, alone or in combination with one or more of the first and second aspects, the transport layer identifier is an IP identifier.

In a fourth aspect, alone or in combination with one or more of the first through third aspects, the transport layer identifier includes at least one of an outer IP address, an IP version 6 flow label, or a DSCP value.

In a fifth aspect, alone or in combination with one or more of the first through fourth aspects, process 600 includes assigning the one or more packets to the one or more tunnels based at least in part on a mapping between the transport layer identifier and a QoS flow identifier.

In a sixth aspect, alone or in combination with one or more of the first through fifth aspects, providing the one or more packets comprises providing a protocol data unit of the QoS flow in a packet, of the one or more packets, with a header field set based at least in part on the transport layer identifier.

In a seventh aspect, alone or in combination with one or more of the first through sixth aspects, the transport layer identifier is an IP header marking.

In an eighth aspect, alone or in combination with one or more of the first through seventh aspects, the network node is a base station.

In a ninth aspect, alone or in combination with one or more of the first through eighth aspects, process 600 includes receiving information associated with the transport layer identifier, and providing the information associated with the transport layer identifier to the UE.

In a tenth aspect, alone or in combination with one or more of the first through ninth aspects, process 600 includes providing information associated with the transport layer identifier to a base station in communication with the UE.

In an eleventh aspect, alone or in combination with one or more of the first through tenth aspects, at least one of the one or more packets includes the transport layer identifier and a QoS flow identifier that maps to the transport layer identifier.

In a twelfth aspect, alone or in combination with one or more of the first through eleventh aspects, process 600 includes transmitting a request for a QoS flow with one or more QoS parameters including at least one of a packet delay budget parameter, a bit rate parameter, a packet error rate parameter, an allocation of a QFI, or a marking of the transport layer identifier.

In a thirteenth aspect, alone or in combination with one or more of the first through twelfth aspects, the network node is the UE.

In a fourteenth aspect, alone or in combination with one or more of the first through thirteenth aspects, process 600 includes transmitting a request for binding of a service data flow associated with the QoS flow to another QoS flow, and receiving configuration information for the other QoS flow as a response to transmitting the request.

In a fifteenth aspect, alone or in combination with one or more of the first through fourteenth aspects, the request is transmitted using NAS signaling, wherein the NAS signaling includes at least one of a PDU session establishment request, or a PDU session modification request.

In a sixteenth aspect, alone or in combination with one or more of the first through fifteenth aspects, process 600 includes binding a service data flow associated with the QoS flow to another QoS flow, and transmitting configuration information for the other QoS flow to a source of a request for the binding of the service data flow.

In a seventeenth aspect, alone or in combination with one or more of the first through sixteenth aspects, a configuration of the QoS flow includes at least one of a QoS rule, a QoS flow description, or a mapping of the QoS flow to an access node resource.

In an eighteenth aspect, alone or in combination with one or more of the first through seventeenth aspects, the QoS flow is a QoS flow of a plurality of established QoS flows marked by corresponding transport layer identifiers.

In a nineteenth aspect, alone or in combination with one or more of the first through eighteenth aspects, providing the one or more packets comprises mapping the one or more packets to an uplink tunnel or a downlink tunnel, of the one or more tunnels, in connection with the transport layer identifier.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a network node, or a network node may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140 or 150. The communication manager 140 or 150 may include one or more of an identification component 708, a mapping component 710, an assignment component 712, or a binding component 714, among other examples.

In some aspects, the apparatus 700 may be configured to perform one or more operations described herein in connection with FIGS. 5A-5C. Additionally, or alternatively, the apparatus 700 may be configured to perform one or more processes described herein, such as process 600 of FIG. 6. In some aspects, the apparatus 700 and/or one or more components shown in FIG. 7 may include one or more components of the network node described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the network node described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the network node described in connection with FIG. 2. In some aspects, the transmission component 704 may be co-located with the reception component 702 in a transceiver.

The identification component 708 may identify a marking of one or more packets, of a QoS flow, with a transport layer identifier associated with a QoS of the QoS flow, wherein the transport layer identifier persists between a UPF and a UE. The transmission component 704 may provide the one or more packets via one or more tunnels with the QoS of the QoS flow. The mapping component 710 may map the transport layer identifier to a QFI.

The assignment component 712 may assign the one or more packets to the one or more tunnels based at least in part on a mapping between the transport layer identifier and a QoS flow identifier. The reception component 702 may receive information associated with the transport layer identifier. The transmission component 704 may provide the information associated with the transport layer identifier to the UE.

The transmission component 704 may provide information associated with the transport layer identifier to a base station in communication with the UE. The transmission component 704 may transmit a request for a QoS flow with one or more QoS parameters including at least one of a packet delay budget parameter, a bit rate parameter, a packet error rate parameter, an allocation of a QoS flow identifier (QFI), or a marking of the transport layer identifier. The transmission component 704 may transmit a request for binding of a service data flow associated with the QoS flow to another QoS flow.

The reception component 702 may receive configuration information for the other QoS flow as a response to transmitting the request. The binding component 714 may bind a service data flow associated with the QoS flow to another QoS flow. The transmission component 704 may transmit configuration information for the other QoS flow to a source of a request for the binding of the service data flow.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram illustrating an example 800 of flow-based end-to-end quality of service (QoS) management, in accordance with the present disclosure. As shown in FIG. 8, example 800 includes a first UE 120-1 and a second UE 120-2, one or more relay nodes 805, a network node 810, an SMF 815, a first UPF 820-1 associated with the first UE 120-1, and a second UPF 820-2 associated with the second UE 120-2.

As further shown in FIG. 8, when the UEs 120 request service (e.g., from an SMF or other network device, not shown), the service may be established for the UE with a particular level of QoS. To provide the particular level of QoS, the UEs 120 may connect to respective UPFs via one or more QoS flows associated with different QoS flow identifiers (QFIs). For example, the first UE 120-1 may have a first QoS flow with a first QFI, QFI-x, established for providing a first QoS level for a first service. Similarly, the second UE 120-2 may have a second QoS flow with a second QFI, QFI-y, established for providing a second QoS level for a second service. When the first UE 120-1 and the second UE 120-2 have respective third and fourth services with a common QoS level (e.g., a third QoS level), the first UE 120-1 and the second UE 120-2 may share a common QoS flow (e.g., with a third QFI, QFI-z). In this case, the first service and the third service may have separated QoS flows (e.g., associated with QFIs QFI-x and QFI-z, respectively).

To establish the different QoS flows, the SMF 815 may communicate with the UPFs 820-1 and cause header information associated with one or more packets to include (e.g., in an IP header field) information associated with indicating which QoS flow is to be used for conveying the one or more packets. In some implementations, the header information may include transport layer information. In some implementations, the UEs 120 may receive information associated with mapping packets to the QoS flows. For example, the UEs 120 may receive information indicating that packets with one or more characteristics (e.g., latency requirements, header information) are to be mapped to particular QoS flows associated with the one or more characteristics.

As indicated above, FIG. 8 is provided as an example. Other examples may differ from what is described with respect to FIG. 8.

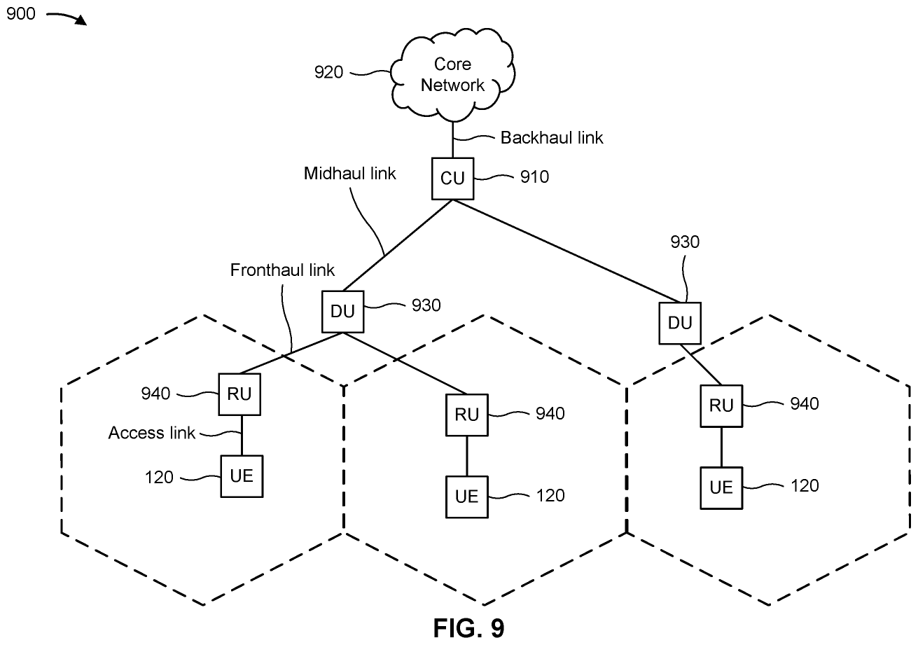

FIG. 9 is a diagram illustrating an example 900 of an open radio access network (O-RAN) architecture, in accordance with the present disclosure. As shown in FIG. 9, the O-RAN architecture may include a control unit (CU) 910 that communicates with a core network 920 via a backhaul link. Furthermore, the CU 910 may communicate with one or more DUs 930 via respective midhaul links The DUs 930 may each communicate with one or more RUs 940 via respective fronthaul links, and the RUs 940 may each communicate with respective UEs 120 via radio frequency (RF) access links The DUs 930 and the RUs 940 may also be referred to as O-RAN DUs (O-DUs) 930 and O-RAN RUs (O-RUs) 940, respectively.

In some aspects, the DUs 930 and the RUs 940 may be implemented according to a functional split architecture in which functionality of a base station 110 (e.g., an eNB or a gNB) is provided by a DU 930 and one or more RUs 940 that communicate over a fronthaul link. Accordingly, as described herein, a base station 110 may include a DU 930 and one or more RUs 940 that may be co-located or geographically distributed. In some aspects, the DU 930 and the associated RU(s) 940 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 930 may correspond to a logical unit that includes one or more base station functions to control the operation of one or more RUs 940. For example, in some aspects, the DU 930 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 910. The RU(s) 940 controlled by a DU 930 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 940 handle all over the air (OTA) communication with a UE 120, and real-time and non-real-time aspects of control and user plane communication with the RU(s) 940 are controlled by the corresponding DU 930, which enables the DU(s) 930 and the CU 910 to be implemented in a cloud-based radio access network architecture.

As indicated above, FIG. 9 is provided as an example. Other examples may differ from what is described with regard to FIG. 9.

The following provides an overview of some Aspects of the present disclosure:

Aspect 1: A method of wireless communication performed by a network node, comprising: identifying a marking of one or more packets, of a quality of service (QoS) flow, with a transport layer identifier associated with a QoS of the QoS flow, wherein the transport layer identifier persists between a user plane function (UPF) and a user equipment (UE); and providing the one or more packets via one or more tunnels with the QoS of the QoS flow.

Aspect 2: The method of Aspect 1, wherein the network node includes a session management function or the UPF.

Aspect 3: The method of any of Aspects 1 to 2, further comprising: mapping the transport layer identifier to a QoS flow identifier (QFI); and wherein providing the one or more packets comprises: providing the one or more packets on the one or more tunnels with the QoS using the QFI. wherein providing the one or more packets comprises: providing the one or more packets on the one or more tunnels with the QoS using the QFI.

Aspect 4: The method of any of Aspects 1 to 3, wherein the transport layer identifier is an Internet Protocol (IP) identifier.

Aspect 5: The method of Aspect 4, wherein the transport layer identifier includes at least one of: an outer IP address, an IP version 6 flow label, or a differentiated services code point (DSCP) value.

Aspect 6: The method of any of Aspects 1 to 5, further comprising: assigning the one or more packets to the one or more tunnels based at least in part on a mapping between the transport layer identifier and a QoS flow identifier.

Aspect 7: The method of any of Aspects 1 to 6, wherein providing the one or more packets comprises: providing a protocol data unit of the QoS flow in a packet, of the one or more packets, with a header field set based at least in part on the transport layer identifier.

Aspect 8: The method of any of Aspects 1 to 7, wherein the transport layer identifier is an IP header marking.

Aspect 9: The method of any of Aspects 1 to 8, wherein the network node is a base station.

Aspect 10: The method of any of Aspects 1 to 9, further comprising: receiving information associated with the transport layer identifier; and providing the information associated with the transport layer identifier to the UE.

Aspect 11: The method of any of Aspects 1 to 10, further comprising: providing information associated with the transport layer identifier to a base station in communication with the UE.

Aspect 12: The method of any of Aspects 1 to 11, wherein at least one of the one or more packets includes the transport layer identifier and a QoS flow identifier that maps to the transport layer identifier.

Aspect 13: The method of any of Aspects 1 to 12, further comprising: transmitting a request for a QoS flow with one or more QoS parameters including at least one of: a packet delay budget parameter, a bit rate parameter, a packet error rate parameter, an allocation of a QoS flow identifier (QFI), or a marking of the transport layer identifier.

Aspect 14: The method of any of Aspects 1 to 13, wherein the network node is the UE.

Aspect 15: The method of any of Aspects 1 to 14, further comprising: transmitting a request for binding of a service data flow associated with the QoS flow to another QoS flow; and receiving configuration information for the other QoS flow as a response to transmitting the request.

Aspect 16: The method of Aspect 15, wherein the request is transmitted using non-access stratum (NAS) signaling, wherein the NAS signaling includes at least one of: a protocol data unit (PDU) session establishment request, or a PDU session modification request.

Aspect 17: The method of any of Aspects 1 to 16, further comprising: binding a service data flow associated with the QoS flow to another QoS flow; and transmitting configuration information for the other QoS flow to a source of a request for the binding of the service data flow.

Aspect 18: The method of any of Aspects 1 to 17, wherein a configuration of the QoS flow includes at least one of: a QoS rule, a QoS flow description, or a mapping of the QoS flow to an access node resource.

Aspect 19: The method of any of Aspects 1 to 18, wherein the QoS flow is a QoS flow of a plurality of established QoS flows marked by corresponding transport layer identifiers.

Aspect 20: The method of any of Aspects 1 to 19, wherein providing the one or more packets comprises: mapping the one or more packets to an uplink tunnel or a downlink tunnel, of the one or more tunnels, in connection with the transport layer identifier.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node for wireless communication, comprising:
a memory; and
one or more processors, coupled to the memory, configured to:
identify a marking of one or more packets, of a quality of service (QoS) flow, with a transport layer identifier associated with a QoS of the QoS flow, wherein the transport layer identifier persists between a user plane function (UPF) and a user equipment (UE); and
provide the one or more packets via one or more tunnels with the QoS of the QoS flow.

2. The network node of claim 1, wherein the network node includes a session management function or the UPF.

3. The network node of claim 1, wherein the one or more processors are further configured to:
map the transport layer identifier to a QoS flow identifier (QFI); and
wherein the one or more processors, to provide the one or more packets, are configured to:
provide the one or more packets on the one or more tunnels with the QoS using the QFI.

4. The network node of claim 1, wherein the transport layer identifier is an Internet Protocol (IP) identifier.

5. The network node of claim 4, wherein the transport layer identifier includes at least one of: an outer IP address, an IP version 6 flow label, or a differentiated services code point (DSCP) value.

6. The network node of claim 1, wherein the one or more processors are further configured to:
assign the one or more packets to the one or more tunnels based at least in part on a mapping between the transport layer identifier and a QoS flow identifier.

7. The network node of claim 1, wherein the one or more processors, to provide the one or more packets, are configured to:
provide a protocol data unit of the QoS flow in a packet, of the one or more packets, with a header field set based at least in part on the transport layer identifier.

8. The network node of claim 1, wherein the transport layer identifier is an IP header marking.

9. The network node of claim 1, wherein the network node is a base station.

10. The network node of claim 1, wherein the one or more processors are further configured to:
receive information associated with the transport layer identifier; and
provide the information associated with the transport layer identifier to the UE.

11. The network node of claim 1, wherein the one or more processors are further configured to:
provide information associated with the transport layer identifier to a base station in communication with the UE.

12. The network node of claim 1, wherein at least one of the one or more packets includes the transport layer identifier and a QoS flow identifier that maps to the transport layer identifier.

13. The network node of claim 1, wherein the one or more processors are further configured to:
transmit a request for a QoS flow with one or more QoS parameters including at least one of:
a packet delay budget parameter,
a bit rate parameter,
a packet error rate parameter,
an allocation of a QoS flow identifier (QFI), or
a marking of the transport layer identifier.

14. The network node of claim 1, wherein the network node is the UE.

15. The network node of claim 1, wherein the one or more processors are further configured to:
transmit a request for binding of a service data flow associated with the QoS flow to another QoS flow; and
receive configuration information for the other QoS flow as a response to transmitting the request.

16. The network node of claim 15, wherein the request is transmitted using non-access stratum (NAS) signaling, wherein the NAS signaling includes at least one of:
a protocol data unit (PDU) session establishment request, or
a PDU session modification request.

17. The network node of claim 1, wherein the one or more processors are further configured to:
bind a service data flow associated with the QoS flow to another QoS flow; and
transmit configuration information for the other QoS flow to a source of a request for the binding of the service data flow, wherein the source is at least one of a UE endpoint, a UPF endpoint, or a base station endpoint of the other QoS flow.

18. The network node of claim 1, wherein a configuration of the QoS flow includes at least one of:
a QoS rule,
a QoS flow description, or
a mapping of the QoS flow to an access node resource.

19. The network node of claim 1, wherein the QoS flow is a QoS flow of a plurality of established QoS flows marked by corresponding transport layer identifiers.

20. The network node of claim 1, wherein the one or more processors, to provide the one or more packets, are configured to:
map the one or more packets to an uplink tunnel or a downlink tunnel, of the one or more tunnels, in connection with the transport layer identifier.

21. A method of wireless communication performed by a network node, comprising:
identifying a marking of one or more packets, of a quality of service (QoS) flow, with a transport layer identifier associated with a QoS of the QoS flow, wherein the transport layer identifier persists between a user plane function (UPF) and a user equipment (UE); and
providing the one or more packets via one or more tunnels with the QoS of the QoS flow.

22. The method of claim 21, wherein the network node includes a session management function or the UPF.

23. The method of claim 21, further comprising:
mapping the transport layer identifier to a QoS flow identifier (QFI); and
wherein providing the one or more packets comprises:
providing the one or more packets on the one or more tunnels with the QoS using the QFI.

24. The method of claim 21, wherein the transport layer identifier is an Internet Protocol (IP) identifier.

25. The method of claim 24, wherein the transport layer identifier includes at least one of:
an outer IP address, an IP version 6 flow label, or a differentiated services code point (DSCP) value.

26. The method of claim 21, further comprising:
assigning the one or more packets to the one or more tunnels based at least in part on a mapping between the transport layer identifier and a QoS flow identifier.

27. The method of claim 21, wherein providing the one or more packets comprises:
providing a protocol data unit of the QoS flow in a packet, of the one or more packets, with a header field set based at least in part on the transport layer identifier.

28. A non-transitory computer-readable medium storing a set of instructions for wireless communication, the set of instructions comprising:
one or more instructions that, when executed by one or more processors of a network node, cause the network node to:
identify a marking of one or more packets, of a quality of service (QoS) flow, with a transport layer identifier associated with a QoS of the QoS flow, wherein the transport layer identifier persists between a user plane function (UPF) and a user equipment (UE); and
provide the one or more packets via one or more tunnels with the QoS of the QoS flow.

29. The non-transitory computer-readable medium of claim 28, wherein the network node includes a session management function or the UPF.

30. An apparatus for wireless communication, comprising:
means for identifying a marking of one or more packets, of a quality of service (QoS) flow, with a transport layer identifier associated with a QoS of the QoS flow, wherein the transport layer identifier persists between a user plane function (UPF) and a user equipment (UE); and
means for providing the one or more packets via one or more tunnels with the QoS of the QoS flow.
